(19) United States
(12) Patent Application Publication
(10) Pub. No.: US 2013/0171288 A1
(43) Pub. Date: Jul. 4, 2013

(54) DEVICE FOR FACILITATING MOLDING OF BREAST IMPLANT SHELLS

(71) Applicant: James A. Harders, Goleta, CA (US)

(72) Inventor: James A. Harders, Goleta, CA (US)

(73) Assignee: ALLERGAN, INC., Irvine, CA (US)

(21) Appl. No.: 13/339,877

(22) Filed: Dec. 29, 2011

(51) Int. Cl. B29C 41/44; B29C 41/40

(52) U.S. Cl. 425/269

(57) ABSTRACT

A system for molding, more specifically demolding, elastomeric breast implant shells is provided. The system generally includes a molding device having a mandrel having a form generally of a breast implant shell and a mandrel rod, couplable to the mandrel. A fluid flow port is provided which is alternately disposable in a concealed position and an exposed position upon rotation of the mandrel rod. When a liquid elastomer coating on the mandrel is cured, the fluid flow port is rotated into the exposed position which allows it to pass air between the cured coating and the molding surface, thereby facilitating disengagement and demolding of the shell from the mandrel.

This invention generally relates to manufacture of inflatable breast prostheses and more specifically relates to a device for facilitating demolding of breast implant shells from molding mandrels.

Prostheses or implants for reconstruction and/or augmentation of the human body are well known.

Fluid filled prostheses, for example, mammary prostheses, or breast implants, are widely used to replace excised tissue, for example after a radical mastectomy, or to augment and improve the appearance of the breasts.

A typical fluid filled breast prostheses generally comprises a elastomeric silicone envelope, or shell, which is filled with saline or silicone gel. The shell itself is commonly manufactured by dip coating several layers of uncured silicone elastomer on a breast implant mold surface, or mandrel, curing the silicone coating and then demolding, i.e. removing or stripping, the cured shell from the mandrel.

The task of stripping the shell from the mandrel can be challenging as it is not automated, is instead done by hand. This manual task involves cutting away a base portion of the elastic shell from the molding apparatus and manually stretching, lifting and peeling the remaining shell from of the mandrel.

U.S. patent application Ser. No. 13/021,523, filed on Feb. 4, 2011, the disclosure of which is incorporated herein in its entirety by this specific reference, describes an inflatable breast prosthesis comprising a silicone elastomer material and a mesh (for example, polyester, Nylon, polypropylene, polyethylene, etc) embedded therein. Among other purposes, the mesh provides structural reinforcement to the shell, and may improve certain physical characteristics such as break force, tensile strength, and modulus of the shell.

However, a shell including mesh reinforcement can be substantially stiffer, or less elastic, than a typical unreinforced shell, which makes the shell even more difficult to remove from a molding mandrel.

The present invention addresses at least some of the difficulties encountered in the breast implant shell manufacturing process, specifically, the process of demolding shells from molding mandrels.

### SUMMARY

Accordingly, systems and devices are provided for facilitating molding of elastomeric breast implant shells, for example, but not exclusively, reinforced breast implant shells.

In one aspect of the invention, the device generally comprises a mandrel having a mold surface, for example, a mold surface having a form generally of a breast implant shell. The device further comprises a mandrel rod couplable to the mandrel, for example, rotatably couplable to the mandrel. For example, in one embodiment, the mandrel includes include a receiving portion, for example an internal threaded surface, and the mandrel rod may include a distal region having a projecting threaded surface engageable with the threaded surface of the mandrel receiving portion.

When fully engaged together, the mandrel and mandrel rod form a device that can be dipped into liquid silicone (with the mandrel fully immersed in liquid silicone elastomer, up to and including at least a portion of the distal end of the mandrel rod) to form a silicone coating that when cured, cut and patched, will form a typical breast implant or tissue expander shell.

In one aspect of the invention, the device further comprises a fluid flow port for facilitating disengagement of the molded shell from the mandrel mold surface. The fluid flow port may be located in any suitable location, for example, in a distal region of the mandrel rod.

In one embodiment, the device is configured such that the fluid flow port is alternately disposable in a first position and a second position. For example, the fluid flow port may be rotated between a first position, or a closed position, and a second position, or open position, for example, upon rotation of the mandrel rod with respect to the mandrel.

In one aspect of the invention, when in the first (or closed) position, the fluid flow port may be concealed within the mandrel, or otherwise structured so that it is sealed from liquid silicone entering the fluid flow port during a mandrel dipping process during shell formation. When in the second (or open) position, the fluid flow port may be in a position such that it is open to allow fluid flow out of the port and between a molded, cured silicone shell and the mandrel.

In one embodiment, the fluid flow port can be closed and alternately open upon a partial rotation of the mandrel rod, for example, a 90 degree rotation of the mandrel rod with respect to the mandrel.

In some embodiments, the mandrel rod further includes a fluid inlet connectable to a fluid source or fluid supply, and a longitudinal channel in communication with the fluid inlet and the fluid flow port. The fluid inlet may be located, for example, in any suitable location, for example, in a proximal region of the mandrel rod which is configured to be couplable to the fluid supply. The fluid supply may provide a flow of low pressure air through the channel and out of the fluid flow port when the fluid flow port is in the open position.

In another aspect of the invention, a system for facilitating molding of elastomeric breast implant shells is provided wherein the system comprises the device as well as a fluid source couplable to the mandrel rod for supplying fluid to the fluid flow port.

Each and every feature described herein, and each and every combination of two or more of such features, is included within the scope of the present invention provided that the features included in such a combination are not mutually inconsistent.

### BRIEF DESCRIPTION OF THE DRAWINGS

The present invention may be more clearly understood and various aspects and advantages thereof may be better appreciated upon consideration of the following Detailed Description and accompanying Drawings of which:

FIG. 1 is a perspective, partial cross-sectional view of one embodiment of the invention, including a mandrel and a mandrel rod couplable thereto.

FIG. 2 is a perspective, partial cross-sectional view of the mandrel rod of the embodiment shown in FIG. 1.

FIGS. 3 and 4 are cross-sectional views of the mandrel rod taken across line 3-3 and line 4-4, respectively, of FIG. 2.

FIG. 5 is another perspective, partial cross-sectional view of the embodiment of the invention shown in FIG. 1, showing the mandrel and a mandrel rod coupled together with a fluid port in a concealed position.

FIG. 6 is another perspective, partial cross-sectional view of the embodiment of the invention shown in FIG. 1, showing the mandrel and a mandrel rod coupled together with the fluid port in an exposed position to facilitate demolding of an elastomeric shell from the mandrel.

### DETAILED DESCRIPTION

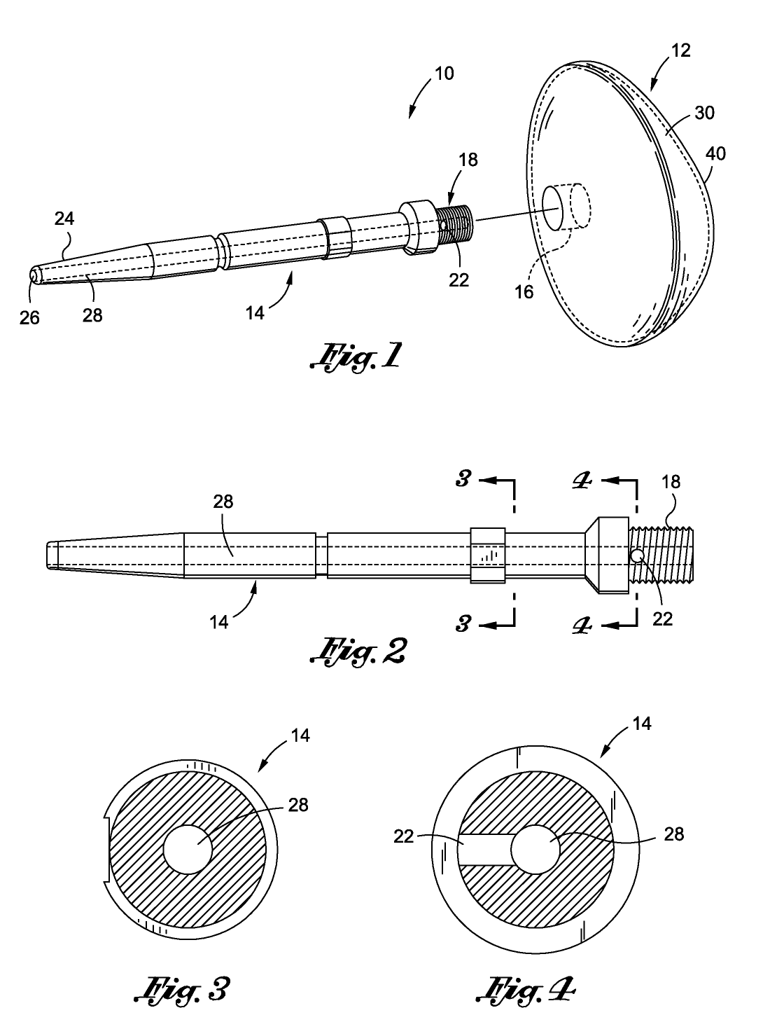

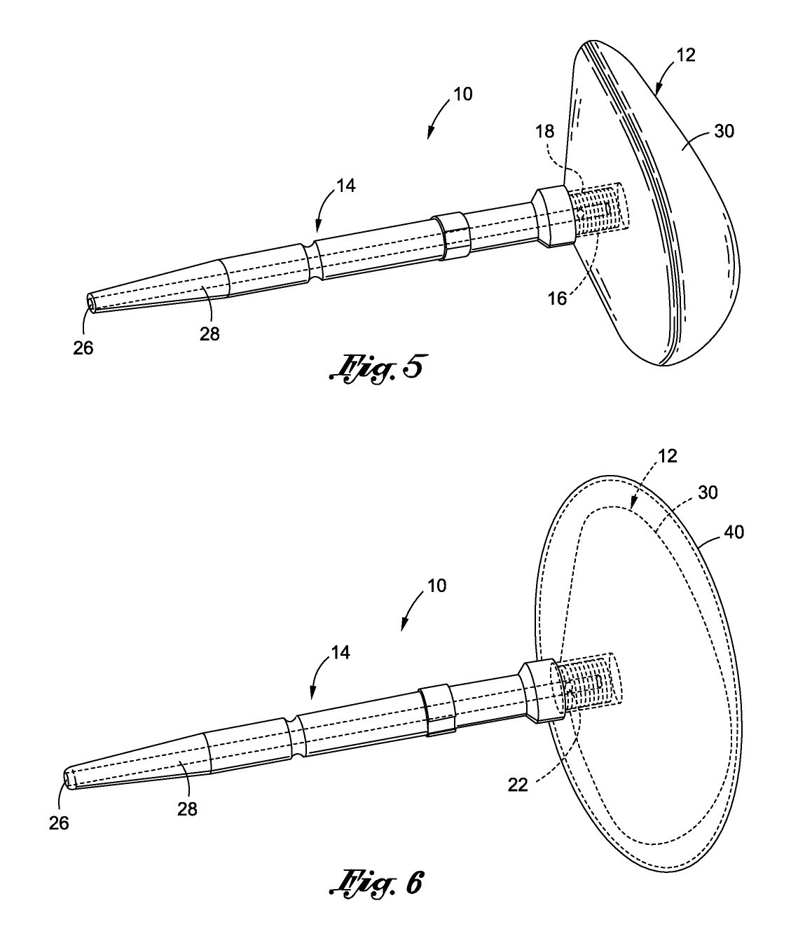

Turning now to FIGS. 1-4, a molding device 10 in accordance with an exemplary embodiment of the invention generally comprises a mandrel 12 and a mandrel rod 14 coupled, for example, rotatably coupled, thereto. The mandrel 12 includes a receiving portion 16 and the mandrel rod 14 includes a distal region 18 couplable to the mandrel receiving portion 16. The mandrel rod distal region 18 and mandrel receiving portion 16 may each include complementary threaded surfaces for facilitating rotatable engagement therebetween.

The device 10 further comprises at least one fluid flow port 22, for example, in the mandrel rod distal region 18, for example, at or near the threaded surface of the mandrel rod distal region 18.

The device 10 is connectable to a fluid flow source (not shown) for example, at a proximal region 20 of the mandrel rod 14, for supplying fluid, for example, a flow of air, to the fluid flow port. The mandrel rod 14 may include, for example, a fluid inlet 26 and a channel 28 leading to the fluid flow port 22. In some embodiments, a plurality of fluid flow ports is provided.

The mandrel 12 is generally in the shape of the item to be molded thereby, for example, the mandrel 12 includes a mold surface 30 having a form generally of a breast implant shell 40.

The mandrel 12 may be made of any suitable material, for example, any polymeric or metallic material, known to be useful for breast implant shell molding surfaces. When coated with a silicone polymeric dispersion, which is then cured, the mandrel 12 forms an elastomeric coating which makes up a molded breast implant shell. Details of this part of the shell molding process are not provided herein, as they are conventional and well known. In some embodiments, the coating may include a mesh embedded therein to form a reinforced breast implant shell or tissue expander shell, such as described in U.S. patent application Ser. No. 13/021,523.

In one embodiment of the invention, the mandrel rod 14 is made of a suitable strong and lightweight molded polymeric material. In another embodiment, the mandrel rod 14 is made of a metal, for example, titanium or a titanium alloy. Commercially Pure type 2 Titanium, herein may be referred to as Titanium CP2, is one example of a suitable material for making the mandrel rod 14. The Titanium CP2 material possesses the property of strength while not adding too much weight to the device 10.

Turning now to FIGS. 5 and 6, the fluid flow port 22 is alternately disposable in a concealed position (FIG. 5), for example, when the mandrel rod 14 is fully seated against the mandrel 12, and in an exposed position (FIG. 6), for example, when the mandrel rod 14 is rotated away from the seated position, for example, upon rotation of the mandrel rod 14 with respect to the mandrel 12.

In this exemplary embodiment of the invention, when in the concealed position, the fluid flow port 22 is covered by the mandrel 12 or otherwise sealed during the silicone dispersion dipping process, such that liquid silicone will not enter the fluid flow port 22 during dipping and coating of the mandrel with liquid silicone. During dipping of the mandrel 12 into liquid silicone, a distal portion of the mandrel rod 14 is also covered and coated with liquid silicone to form somewhat of a silicone sleeve portion about the distal portion of the mandrel rod.

Once the silicone coating (or coatings) forming the elastomeric implant shell is cured, or at least stabilized, the fluid flow port 22 is rotated into the exposed position (FIG. 6). In the exposed position, the fluid flow port 22 is moved out of the concealed position in the mandrel, and is directly covered by the cured molded silicone elastomer material, for example, the sleeve portion of the silicone shell. Fluid, such as a flow of air, is applied to the fluid flow port, for example by means of the fluid supply (not shown) connected to the fluid inlet 26. More specifically, the fluid flow port 22, in this position, can release air flow, for example, by application of low-pressure air from the fluid flow source from inlet 26 through channel 28.

To cause disengagement between the molded silicone elatomeric coating and the mandrel 12, fluid flow may be provided at, for example, a pressure of between about 10 psi and about 20 psi or greater, for example, about 12 psi, through the fluid flow port 22. This may vary depending upon the relative elasticity of the shell and whether the shell is reinforced or not reinforced, as described elsewhere herein. Application of air through the fluid flow port 22 causes the elastomeric shell 40 to demold, for example, inflate and detach from the mandrel surface 30 (see FIG. 6), thus greatly facilitating the final manual removal of the shell from the mandrel 12.

Generally, then, it can be appreciated that the present device 10 provides a relatively straightforward and rather efficient way to facilitate separation of an elastomeric shell from the mandrel mold surface 30 during the implant shell manufacturing process.

In an exemplary embodiment for using the device 10 to form a molded silicone shell, the mandrel 12 having mandrel rod 14 attached thereto with the fluid flow port 22 in the concealed position, is coated, one or more times, with liquid silicone. During the coating process, a sufficient amount of silicone material is applied to fully coat the molding surface 30 of the mandrel 12 and also to partially cover at least a portion of the mandrel rod distal region 18. Again, this coating process is performed while the fluid flow port(s) 22 on the mandrel rod 14 is in the concealed position (e.g. fully seated position), for example, with the fluid flow port(s) is fully concealed within the receiving portion 16 of the mandrel 12. The silicone coating is then cured or at least stabilized to form an elastomeric shell on the device 10.

Prior to the application of the low-pressure air to facilitate removal of the molded silicone shell 40, the mandrel rod 14 is rotated, or unscrewed, for example, about 90 degrees or at approximately ¼ turn, with respect to the mandrel 12, thereby exposing the fluid flow port(s) to an inside surface of the molded silicone shell 40. This rotation of the mandrel rod may be done by hand. It will, of course, be appreciated that exposing the fluid flow port(s) to the inside of the silicone shell (exposed position) may be accomplished upon rotation of the mandrel rod 14 less than 90 degrees or greater than 90 degrees, depending upon the location of the fluid flow port(s) and/or the thread pitch or other structure of the coupling between the mandrel 12 and mandrel rod 14. Exposure of the fluid flow port(s) 22 to the shell interior surface (for example, within the sleeve portion of the elastomeric coating covering a distal portion of the mandrel rod 14) will allow the air flow from the fluid flow port(s) 22 to detach and inflate the shell 40, such as shown in FIG. 6. Thus, when the fluid flow port 22 is in the exposed position, at least a partial seal is sufficiently maintained by the elastomeric shell 40 at the mandrel rod distal region 18 thus allowing the air flow to be directed into the elastomeric shell 40 via the fluid flow port(s) 22.

Finally, once the shell 40 has been separated from the mandrel 12, the shell 40 may then be cut at the junction of the mandrel rod 14 and mandrel 12, as per usual custom, to allow for further processing such as removing the shell 40 from the mandrel 12.

While this invention has been described with respect to various specific examples and embodiments, it is to be understood that the invention is not limited thereto and that it can be variously practiced within the scope of the invention.

What is claimed is:

1. A device for molding elastomeric breast implant shells, the device comprising:
a mandrel having a receiving portion and a mold surface having a form generally of a breast implant shell;
a mandrel rod having a distal region couplable to the mandrel receiving portion; and
a fluid flow port at the distal region of the mandrel rod;
the device being configured such that the fluid flow port is alternately disposable in a first position and an second position.

2. The device of claim 1 wherein the mandrel rod is rotatably couplable to the mandrel receiving portion.

3. The device of claim 1 wherein the mandrel rod distal region comprises a threaded surface engageable with the mandrel receiving portion.

4. The device of claim 1 wherein the mandrel rod distal region comprises a threaded surface engageable with a threaded surface of the mandrel receiving portion.

5. The device of claim 1 configured such that the fluid flow port is alternately disposable in a concealed position and an exposed position upon rotation of the mandrel rod with respect to the mandrel.

6. The device of claim 1 wherein the mandrel rod includes a proximal region couplable to a fluid source.

7. The device of claim 1 wherein the mandrel rod includes a longitudinal channel in communication with the fluid flow port.

8. The device of claim 1 wherein the mandrel rod includes a longitudinal channel in communication with the fluid flow port.

9. The device of claim 1 wherein the mandrel rod includes a longitudinal channel in communication with the fluid flow port and a proximal region couplable to a fluid source.

10. The device of claim 1 configured such that the fluid flow port is alternately disposable in a concealed position and an exposed position upon rotation of the mandrel rod of about 90 degrees with respect to the mandrel.

11. A system for molding elastomeric breast implant shells, the system comprising:
a molding device comprising
a mandrel having a receiving portion and a mold surface having a form generally of a breast implant shell,
a mandrel rod, couplable to a fluid source, and including a distal region couplable to the mandrel receiving portion, and
a fluid flow port at the distal region of the mandrel rod, the fluid flow port being alternately disposable in a first position and a second position upon rotation of the mandrel rod with respect to the mandrel; and
a fluid source couplable to the mandrel rod for supplying fluid to the fluid flow port.

12. The device of claim 11 wherein the fluid source provides air pressure of between about 10 psi and about 20 psi.

13. The device of claim 11 wherein the fluid source provides air pressure of about 12 psi.

14. The device of claim 11 wherein the mandrel rod distal region comprises a threaded surface engageable with the mandrel receiving portion.

15. The device of claim 11 wherein the mandrel rod distal region comprises a threaded surface engageable with a threaded surface of the mandrel receiving portion.

16. The system of claim 11 wherein the mandrel rod includes a longitudinal channel in communication with the fluid flow port.

17. A device for molding elastomeric breast implant shells, the device comprising:
a mandrel having a receiving portion and a mold surface having a form generally of a breast implant shell;
a mandrel rod having a distal region couplable to the mandrel receiving portion; and
a fluid flow port at the distal region of the mandrel rod; and
a channel through the mandrel rod and in communication with the fluid flow port and a fluid source;
the device being configured such that when a flow of fluid is passed from the fluid source and into the channel and out of the fluid flow port, a cured breast implant shell molded on the mandrel inflate and become disengaged from the mandrel.
